(19) United States
(12) Patent Application Publication
(10) Pub. No.: US 2017/0365881 A1
(43) Pub. Date: Dec. 21, 2017

(54) NANICL BATTERY AND MODULE USING SAME

(71) Applicant: POSCO ENERGY CO., LTD., Seoul (KR)

(72) Inventor: Hyo Seok LEE, Seoul (KR)

(21) Appl. No.: 15/539,218

(22) PCT Filed: May 15, 2015
(86) PCT No.: PCT/KR2015/004894

§ 371 Date: Jun. 23, 2017

(30) Foreign Application Priority Data
Dec. 29, 2014 (KR) 10-2014-0191750

(51) Int. Cl. H01M 10/38; H01M 10/0562; C01F 7/02; C01G 53/09; C01G 53/00; H01M 10/39; H01M 2/02; H01M 2/20

(52) U.S. Cl. CPC H01M 10/38; C01G 53/006; H01M 10/0562; H01M 10/39; C01F 7/028; C01G 53/09; H01M 2/208; H01M 2/0217

(57) ABSTRACT

A NaNiCl battery and a module using the same are provided. A NaNiCl battery according to the present invention include: a case that forms an exterior shape of the battery; and a beta alumina solid electrolyte (BASE) tube that is provided in the case and having a clover-shaped cross-section, wherein the case has a clover-shaped cross-section like the clover-shaped cross-section of the BASE tube to minimize a space between the case and the BASE tube.

### TECHNICAL FIELD

The present invention relates to a sodium nickel chloride (NaNiCl) battery, and a module using the same. More particularly, the present invention relates to a NaNiCl battery having a new shape to reduce a volume of a module formed of the NaNiCl battery, and a module using the same.

### BACKGROUND ART

In general, as shown in FIG. 1, a NaNiCl battery is formed in the shape of a cuboid, and as shown in FIG. 2, a module is formed by arranging a plurality of cuboid NaNiCl batteries 3 in parallel in a module case 1.

FIG. 3 is a schematic cross-sectional view of a conventional NaNiCl battery, and FIG. 4 is a photograph of a clover-shaped beta alumina solid electrolyte (BASE) tube, which is a part of the conventional NaNiCl battery.

Referring to FIG. 3 and FIG. 4, a BASE tube 7 of the conventional NaNiCl battery has a clover-shaped cross-section, and a battery case 5 has a quadrangular-shaped cross-section.

Since the BASE tube 7 is disposed in the battery case 5, the battery case 5 has the quadrangular-shaped cross-section, and the BASE tube 7 has the clover-shaped cross-section, unnecessary space 9 may be formed between the quadrangle shape of the battery case 5 and the clover shape of the BASE tube 7.

### DISCLOSURE

### Technical Problem

The present invention has been made in an effort to provide a NaNiCl battery having a new shape to reduce a volume of a module formed of the NaNiCl batteries, and a module using the same.

### Technical Solution

A NaNiCl battery according to an exemplary embodiment of the present invention include: a case that forms an exterior shape of the battery; and a beta alumina solid electrolyte (BASE) tube that is provided in the case and having a clover-shaped cross-section, wherein the case has a clover-shaped cross-section like the clover-shaped cross-section of the BASE tube to minimize a space between the case and the BASE tube.

The case may have a clover-shaped cross-section like the clover-shaped cross-section of the BASE tube to minimize a space between the case and the BASE tube.

The clover-shaped cross-section of the case may be formed to correspond to the clover-shaped cross-section of the BASE tube.

A constant gap may be formed along the edge of the case to minimize a space between the case and the BASE tube.

The case may include: four convex portions that protrude with a regular interval with reference to the center of the case such that the case has a clover-like shape; and four recess portions that are concave with a regular interval with reference to the center of the case and correspondingly coupled with the convex portions

The convex portions may respectively have curved shapes that protrude to the outside from the center of the case with a constant-sized curvature with reference to the center of the case.

The recess portions may respectively have curved shapes that are concave toward the center from the outside the case with a constant-sized curvature to connect neighboring.

According to another exemplary embodiment of the present invention, a module using a NaNiCl battery that includes a case that forms an exterior shape of the battery and a beta alumina solid electrolyte (BASE) provided in the case and having a clover-shaped cross-section, wherein the case has a clover-shaped cross-section like the clover-shaped cross-section of the BASE.

The module may include a plurality of NaNiCl batteries and may be formed by arranging the plurality of NaNiCl batteries, each NaNiCl battery formed in a manner such that convex portions and recess portions of one NaNiCl battery are correspondingly coupled to recess portions and convex portions of another adjacent NaNiCl battery in the case to improve efficiency of a module space.

Each NaNiCl battery may include: four convex portions that protrude with a regular interval with reference to the center of the case to form the shape of the case to be a clover shape; and four recess portions that are convex with a regular interval with reference to the center of the case to be correspondingly coupled with the convex portions.

The convex portions may have curved shapes that protrude to the outside from the center of the case with a constant-sized curvature with reference to the center of the case.

The recess portions have curved shapes that are concave toward the center of the case from the outside of the case with a constant-sized curvature to connect neighboring convex portions.

### Advantageous Effects

According to the exemplary embodiments of the present invention, a new shape of the NaNiCl battery is proposed to reduce the volume of a module formed of the NaNiCl batteries, and the module is formed by the NaNiCl batteries having the new shape, thereby reducing the volume of the module.

### DESCRIPTION OF THE DRAWINGS

FIG. 1 shows a conventional NaNiCl battery.

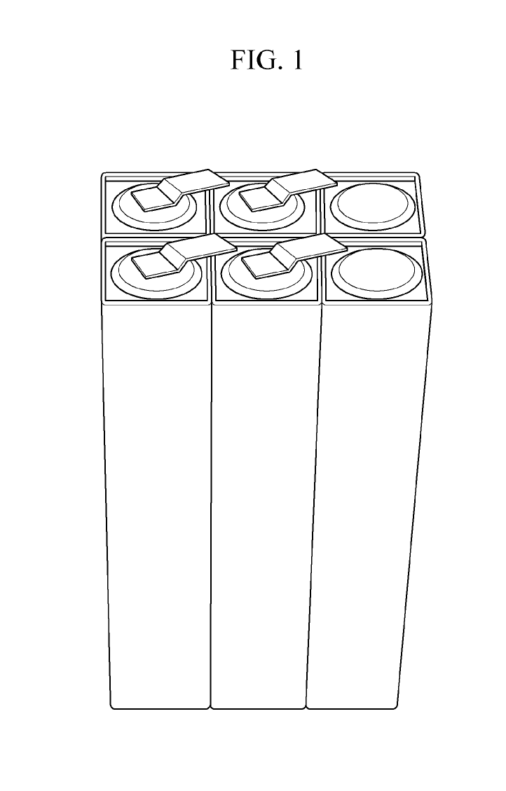

FIG. 2 is a schematic perspective view of a NaNiCl battery module.

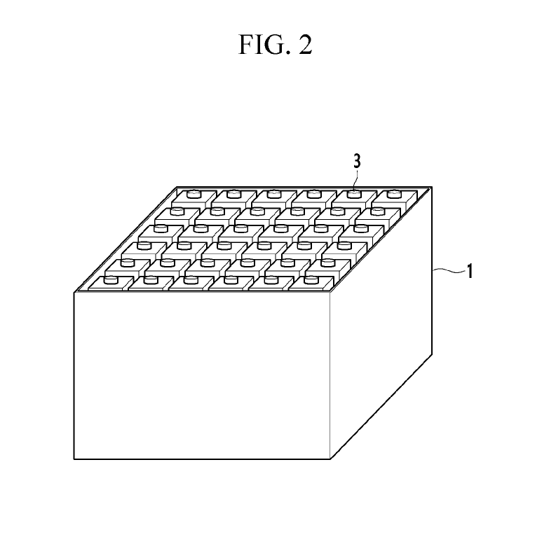

FIG. 3 is a schematic cross-sectional view of the conventional NaNiCl battery.

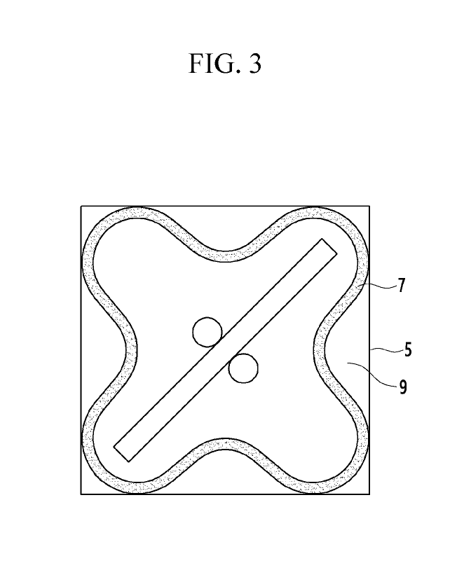

FIG. 4 shows a beta alumina solid electrolyte (BASE) tube having a clover shape, as an internal part of the conventional NaNiCl battery.

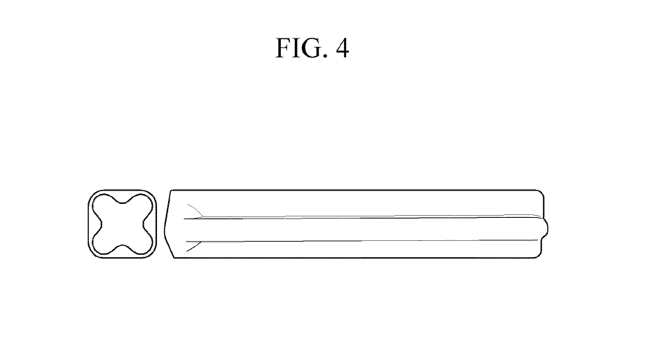

FIG. 5 is a schematic cross-sectional view of a NaNiCl battery according to an exemplary embodiment of the present invention.

FIG. 6 is a schematic cross-sectional view of a layout of the NaNiCl batteries according to the exemplary embodiment of the present invention.

FIG. 7 is a schematic diagram of a module formed by the NaNiCl batteries according to the exemplary embodiment of the present invention.

### MODE FOR INVENTION

Hereinafter, the present invention will be described more fully with reference to the accompanying drawings, in which exemplary embodiments of the invention are shown. As is easily understood by the person with ordinary skill in the art to which the present invention pertains, the exemplary embodiments which will be described below may be variously modified without departing from the spirit and the scope of the present invention. If possible, the same or similar portions are represented by using the same reference numeral in the drawings.

The terminologies used hereinafter are set forth just to illustrate a specific exemplary embodiment but not to limit the present invention. It must be noted that, as used in the specification and the appended claims, the singular forms include plural references unless the context clearly dictates otherwise. It will be further understood that the term “comprises”, when used in this specification, specifies the presence of stated properties, regions, integers, steps, operations, elements, and/or components, but does not preclude the presence or addition of one or more other properties, regions, integers, steps, operations, elements, components, and/or groups.

All terms including technical terms and scientific terms used herein have the same meaning as that generally understood by the person with ordinary skill in the art to which the present invention pertains. The terminologies that are defined previously are further understood to have the meaning that coincides with relating technical documents and the contents that are currently disclosed, but not interpreted as the ideal or very official meaning unless so defined.

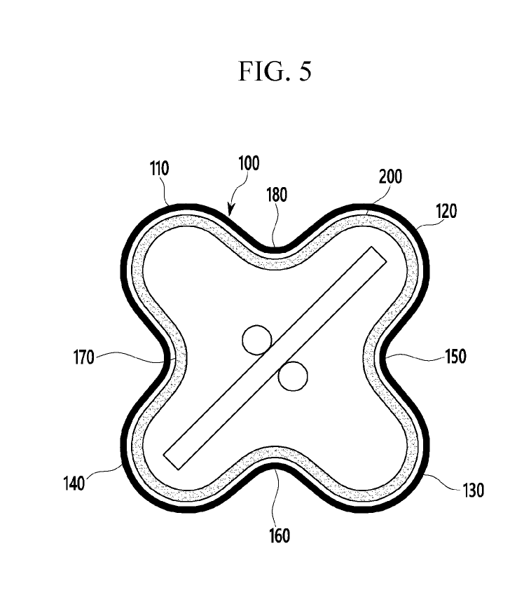

FIG. 5 is a schematic cross-sectional view of a NaNiCl battery according to an exemplary embodiment of the present invention.

Referring to FIG. 5, a NaNiCl battery 10 according to an exemplary embodiment includes a case 100 that forms an exterior surface of the battery 10, and a BASE tube 200 that is disposed in the case 100 and has a clover-shaped cross-section.

A cross-sectional shape of the case 100 may be a clover shape like the clover shape of the BASE tube 200 to minimize a space between the case 100 and the BASE tube 200.

The clover-shaped cross-section of the case 100 may be formed to correspond to the clover-shaped cross-section of the BASE tube 200.

A constant gap may be formed along the edge of the case 100 so as to minimize the space between the case 100 and the BASE tube 200.

The case 100 includes four convex portions 110, 120, 130, and 140 that protrude apart from each other at regular intervals with reference to the center of the case to thereby form the clover shape, and four recess portions 150, 160, 170, and 180 that are concave at regular intervals with reference to the center of the base 100 so as to be correspondingly combined with the convex portions 110, 120, 130, and 140.

The convex portions 110, 120, 130, and 140 may each have a curved shape that protrudes to the outside from the center of the case 100 with a constant curvature with reference to the center of the case 100.

In addition, the recess portions 150, 160, 170, and 180 may each have a curved shape that is concave to the center side from the outside of the case 100 with a constant curvature so as to connect the convex portions 110, 120, 130, and 140 that are adjacent to each other.

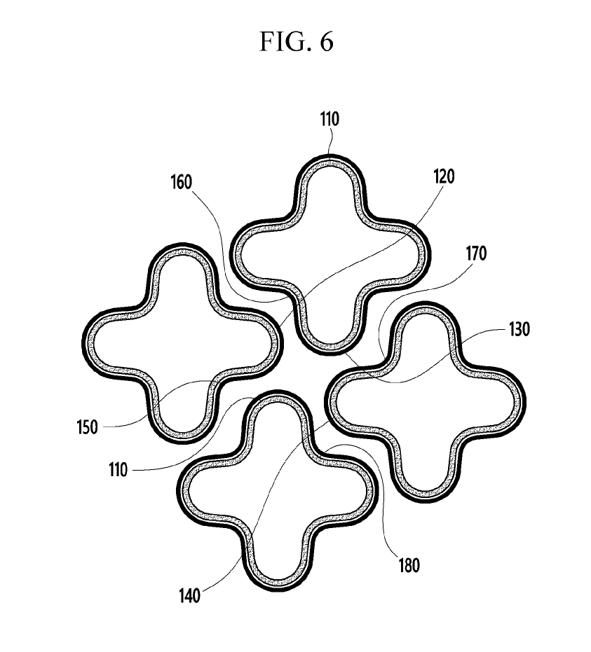

FIG. 6 is a schematic cross-sectional view of a layout state of the NaNiCl batteries according to the exemplary embodiment of the present invention.

Referring to FIG. 6, the convex portions 110, 120, 130, and 140 and recess portions 150, 160, 170, and 180 of each NaNiCl battery 10 may be correspondingly coupled to recess portions 150, 160, 170, and 180 and convex portions 110, 120, 130 of another NaNiCl battery 10 that adjacent to the NaNiCl battery 10.

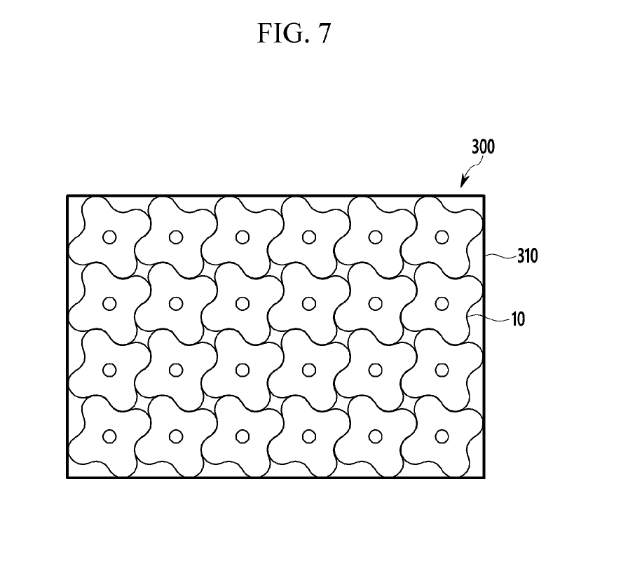

In addition, FIG. 7 is a schematic diagram of a module that uses NaNiCl batteries according to an exemplary embodiment of the present invention.

Referring to FIG. 7, a module 300 using NaNiCl batteries may be formed by arranging a plurality of NaNiCl batteries in a module case 310. The convex portions and the recess portions of each NaNiCl battery 10 in the module case 310 are correspondingly coupled to recess portions and convex portions of neighboring NaNiCl batteries such that efficiency of a module space can be improved.

Hereinafter, referring to FIG. 5 to FIG. 7, a NaNiCl battery and operation of a module using the same according to the exemplary embodiment of the present invention will be described.

A shape of a cross-section of the case 100 is a shape of a clover like the clover shape of the BASE tube 200, and thus a space between the case 100 and the BASE tube 200 can be minimized.

In addition, the case 100 includes the four convex portions 110, 120, 130, and 140 that protrude at regular intervals with reference to the center of the case, and the four recess portions 150, 160, 170, and 180 that are concave at regular intervals with reference to the center of the base 100 so as to be correspondingly combined with the convex portions 110, 120, 130, and 140, and accordingly, the case 100 may have a clover shape.

In addition, the convex portions 110, 120, 130, and 140 may each have a curved shape that protrudes to the outside from the center of the case 100 with a constant curvature with reference to the center of the case 100, and the recess portions 150, 160, 170, and 180 may each have a curved shape that is concave to the center side from the outside of the case 100 with a constant curvature so as to connect the convex portions 110, 120, 130, and 140 that are adjacent to each other.

Accordingly, the convex portions 110, 120, 130, and 140 and recess portions 150, 160, 170, and 180 of each NaNiCl battery 10 may be correspondingly coupled to recess portions 150, 160, 170, and 180 and convex portions 110, 120, 130 of another NaNiCl battery 10 that is adjacent to the NaNiCl battery 10.

A module 300 using NaNiCl batteries may be formed by arranging a plurality of NaNiCl batteries in the module case 310. The convex portions and the recess portions of each NaNiCl battery 10 in a module case 310 are correspondingly coupled to recess portions and convex portions of neighboring NaNiCl batteries such that efficiency of a module space can be improved, and accordingly, a volume of the module formed of the NaNiCl batteries can be reduced.

### <Description of Symbols>

10: NaNiCl battery

100: case

200: BASE tube

300: module using NaNiCl batteries

310: module case

1. A sodium nickel chloride (NaNiCl) battery comprising:
a case that forms an exterior shape of the battery; and
a beta alumina solid electrolyte (BASE) tube that is provided in the case and having a clover-shaped cross-section,
wherein the case has a clover-shaped cross-section like the clover-shaped cross-section of the BASE tube to minimize a space between the case and the BASE tube.

2. The NaNiCl battery of claim 1, wherein the case has a clover-shaped cross-section like the clover-shaped cross-section of the BASE tube to minimize a space between the case and the BASE tube.

3. The NaNiCl battery of claim 2, wherein the clover-shaped cross-section of the case is formed to correspond to the clover-shaped cross-section of the BASE tube.

4. The NaNiCl battery of claim 3, wherein a constant gap is formed along the edge of the case to minimize a space between the case and the BASE tube.

5. The NaNiCl battery of claim 1, wherein the case comprises:
four convex portions that protrude with a regular interval with reference to the center of the case such that the case has a clover-like shape; and
four recess portions that are concave with a regular interval with reference to the center of the case and correspondingly coupled with the convex portions.

6. The NaNiCl battery of claim 5, wherein the convex portions respectively have curved shapes that protrude to the outside from the center of the case with a constant-sized curvature with reference to the center of the case.

7. The NaNiCl battery of claim 6, wherein the recess portions respectively have curved shapes that are concave toward the center from the outside the case with a constant-sized curvature to connect neighboring convex portions.

8. A module using a sodium nickel chloride (NaNiCl) battery that comprises a case that forms an exterior shape of the battery and a beta alumina solid electrolyte (BASE) provided in the case and having a clover-shaped cross-section, wherein the case has a clover-shaped cross-section like the clover-shaped cross-section of the BASE,
the module comprising a plurality of NaNiCl batteries and formed by arranging the plurality of NaNiCl batteries, each NaNiCl battery formed in a manner such that convex portions and recess portions of one NaNiCl battery are correspondingly coupled to recess portions and convex portions of another adjacent NaNiCl battery in the case to improve efficiency of a module space.

9. The module using the NaNiCl batteries of claim 8, wherein each NaNiCl battery comprises:
four convex portions that protrude with a regular interval with reference to the center of the case to form the shape of the case to be a clover shape; and
four recess portions that are convex with a regular interval with reference to the center of the case to be correspondingly coupled with the convex portions.

10. The module using the NaNiCl batteries of claim 9, wherein the convex portions have curved shapes that protrude to the outside from the center of the case with a constant-sized curvature with reference to the center of the case.

11. The module using the NaNiCl batteries of claim 10, wherein the recess portions have curved shapes that are concave toward the center of the case from the outside of the case with a constant-sized curvature to connect neighboring convex portions.
